(19) United States
(12) Patent Application Publication
(10) Pub. No.: US 2021/0269211 A1
(43) Pub. Date: Sep. 2, 2021

(54) ENVIRONMENT PROTECTED STARCH CONTAINER DEVICE WITH HIGH HARDNESS AND A FUNCTION OF EASY SEPARATION FROM A MOLD

(71) Applicant: CHEN WEI WANG, New Taipei City (TW)

(72) Inventor: CHEN WEI WANG, New Taipei City (TW)

(21) Appl. No.: 17/325,226

(22) Filed: May 20, 2021

Related U.S. Application Data
(63) Continuation of application No. 16/299,167, filed on Mar. 12, 2019.

(51) Int. Cl. B65D 65/46; B65D 1/36; B65D 1/26; B65D 65/42

(52) U.S. Cl. CPC B65D 65/466; B65D 65/42; B65D 1/265; B65D 1/36

(57) ABSTRACT

An environment protected starch container device with high hardness and a function of easy separation from a mold includes a starch container mainly made of starch material for holding solid or liquid foods or other objects; and a silicon layer adhered to a surface of the starch container. The function of the silicon layer is to cause the starch container to be waterproof; furthermore the silicon layer and the starch container are capably of decomposition naturally without polluting the environment; therefore the container is capable of holding water therein and is reusable for many times. The starch material comprises 50 wt %˜90 wt % (weight percentage) starch; 5 wt %˜25 wt % fiber enhancer for enhancing a structure of the starch material; and 3 wt %˜30 wt % CaCO3 for hardening the structure of the starch material. The starch material may further comprise 0.02 wt %˜5 wt % foaming material. The starch material is mixed with stearic acid; and the silicon layer further comprises of quartz.

The present invention is a continuation in part of U.S. patent application Ser. No. 16/299,167, which has the same inventor and applicant of the present invention. Therefore, the contents of U.S. patent Ser. No. 16/299,167 is incorporated into the present invention as a part of the present invention.

### FIELD OF THE INVENTION

The present invention is related to starch containers, and in particular to an environment protected starch container device with high hardness and a function of easy separation from a mold.

### BACKGROUND OF THE INVENTION

The starch material in the prior art mainly comprises 50 wt %˜90 wt % (weight percentage) starch; 5 wt %˜25 wt % fiber enhancer; 0.2 wt %˜3 wt % steady agent; and 5 wt %˜40 wt % filling powders; preferably, 0.5 wt %˜5 wt % foaming material is added thereto. The environment of forming the starch material is high humidity environment (the humidity is about 80%). The starch material is formed as blocks so as to mix with water. To cause water is uniformly distributed in the starch material, the starch material is rubbed many times until the hardness of the surface of the starch material is between 10 HA˜20 HA.

The starch of the starch material is selected from potato starch, corn starch, wood starch, or other plant starch. Because the particles of these starches are not preferred so that water is used to concrete the structure of the starch material. When the starch material is placed in a shaping space and then compressed and heated to temperature of about 100° C., water therein will evaporate to be formed with a plurality of holes in the porous starch container.

The wastes of starch foaming material and the manufacturing products thereof can be biologically decomposed after unused and may be further used in other fields so as not to pollute the environment. The starch foaming material can be processed by burning. Furthermore after burning, the product of CO2 for general used plastics is 3.13 tons, while it is 0.6 tons for starch foaming material, which has a reduction of 80-90%. Furthermore in the burning process, the products are harmful and the residue may be used as fertilizer.

Conventionally, paper is used as material for making food containers, however, paper is not preferred biological material. Furthermore the prior paper cup is coated with a layer of PP or PE for waterproof, but PP and PE are plastic material which is harmful to human bodies and cannot be decomposed naturally so as to pollute the environment.

The inventor has developed starch material for many years and uses these materials in food container. However, the starch material has no function of waterproof. It is easy to resolve and deform and thus is not suitable to receive liquid. Therefore, the usage of the starch container is greatly confined.

However, the starch material has many advantages as above said and thus the inventor is desired to improve this defect in the starch material to provide a novel starch container which is suitable for-receiving liquid.

### SUMMARY OF THE INVENTION

Accordingly, for improving above mentioned defects in the prior art, the object of the present invention is to provide an environment protected starch container device with high hardness and a function of easy separation from a mold, wherein The function of the silicon layer 20 is to cause the starch container 10 to be waterproof. Furthermore in natural environment, the silicon layer 20 and the starch container 10 are capably of decomposition naturally without polluting the environment. Therefore, it is better than the prior art used paper cups made of the PP or PE. Furthermore the silicon layer 20 is endurable to temperatures higher than 250° C. and capable of suffering from high temperature and has the function of killing bacteria in high temperature. The conventionally containers made of PE or PU only suffer from temperatures not over than 20° C. However, the starch container 10 of the present invention is coated with a silicon layer 20 which can suffer from temperatures over than 250° C. Therefore, the medical instruments made of the material of the present invention are useable for killing bacteria on high temperature, while this effect cannot be achieved by the conventional container.

To achieve above object, the present invention provides an environment protected starch container device with high hardness and a function of easy separation from a mold; comprising; a starch container mainly made of starch material for holding solid or liquid foods or other objects; a silicon layer adhered to a surface of the starch container; and wherein the function of the silicon layer is to cause the starch container to be waterproof; originally, the starch container is not waterproof; furthermore in natural environment, the silicon layer and the starch container are capably of decomposition naturally without polluting the environment; therefore the container is capable of holding water therein and is reusable for many times.

The starch material comprises 50 wt %˜90 wt % (weight percentage) starch; 5 wt %˜25 wt % fiber enhancer for enhancing a structure of the starch material; and 3 wt %˜30 wt % CaCO3 for hardening the structure of the starch material. The starch material may further comprise 0.02 wt %˜5 wt % foaming material.

The starch material is mixed with stearic acid; a weight of the stearic acid is 1 to 25 wt % (weight percentage) of a weight of the starch material; the mixture of the stearic acid with the starch material 11 has lower viscosity; and therefore, in manufacturing process, the starch container can be taken out from a manufacturing mold easily; and furthermore the stearic acid is easily decomposed so that it has no harm to the environment.

The silicon layer further comprises of quartz; a weight of the quartz is 1 to 25 wt % (weight percentage) of the weight of the silicon layer; the quartz has a function of enhancing a hardness of the whole silicon layer so that the hardness of the whole starch container is enhanced.

### BRIEF DESCRIPTION OF THE DRAWINGS

FIG. 1 is a schematic view showing a cup of a starch container according to the present invention.

FIG. 2A is a cross section view of FIG. 1.

FIG. 2B is a partial view of FIG. 2A.

FIG. 3 is a schematic view showing the present invention being used as a food disk.

FIG. 4 is a cross section view of FIG. 3.

FIG. 5 is another schematic view showing another example for the food disk of the present invention.

FIG. 6 is a cross section view of FIG. 5.

FIG. 7 is a schematic view showing the starch container being a bowl according to the present invention.

FIG. 8 is a cross section view of FIG. 7.

FIG. 9 is a schematic view showing that the starch container is a food box according to the present invention.

FIG. 10 is a cross section view of FIG. 9.

FIG. 11 is a schematic view of a box of a starch container of the present invention.

FIG. 12 is cross section view of FIG. 11.

FIG. 13 is another schematic view about a box made of starch container according to the present invention.

FIG. 14 is a cross section view of FIG. 13.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

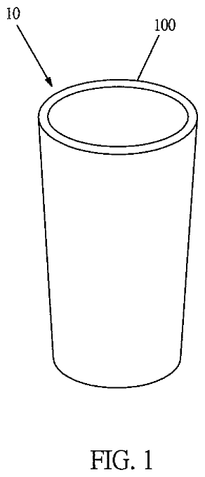

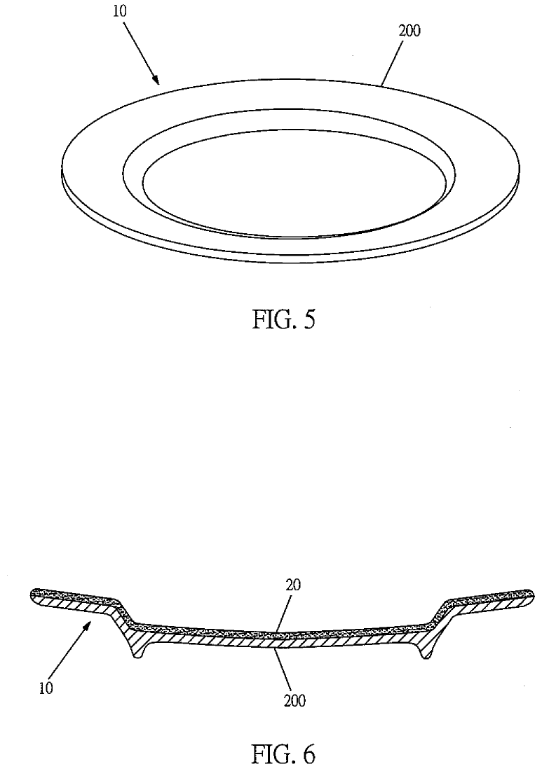

With reference to FIGS. 1 to 14, the starch container with a silicon layer according to the present invention is illustrated. The present invention includes the following elements.

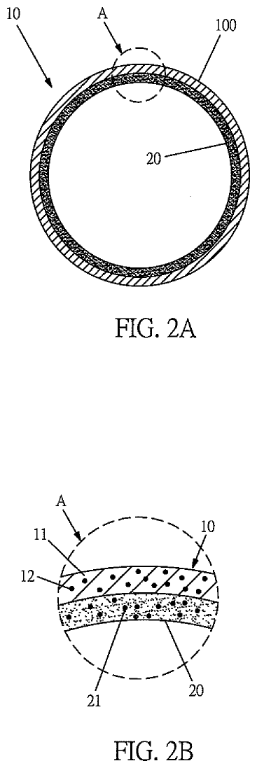

A starch container 10 is mainly made of starch material 11 for receiving solid or liquid foods or other objects (referring to FIG. 1 to FIGS. 2A and 2B).

The starch material 11 is mixed with stearic acid 12. The weight of the stearic acid 12 is 1 to 25 wt % (weight percentage) of the weight of the starch material 11. The function is that the mixture of the stearic acid 12 with the starch material 11 has lower viscosity. Therefore, in manufacturing process, the starch container 10 can be taken out from a manufacturing mold easily. Furthermore the stearic acid 12 is easily decomposed so that it has no harm to the environment.

The starch material 11 is further mixed with at least one of additives including polyethylene (PE), polypropylene (PP), polystyrene (PVC), ethylene, ethylene vinyl acetate (PVC), thermal plastic rubber (TPR). The weight of the additive is 1 to 10 wt % (weight percentage) of the weight of the starch material 11.

A silicon layer 20 is adhered to a surface of the starch container 10. Preferably, the silicon layer 20 is adhered to an inner surface of the starch container 10.

With reference to FIGS. 2A and 2B, the silicon layer 20 further comprises of quartz 21. The weight of the quartz is 1 to 25 wt % (weight percentage) of the weight of the silicon layer 20. The quartz has the function of enhancing the hardness of the whole silicon layer 20 so that the hardness of the whole starch container 10 is enhanced. Therefore, the starch container 10 of the present invention is wear-proof. Furthermore the quartz is poisonous and thus is not harmful to the environment.

Preferably, the silicon layer 20 is adhered to a whole surface of the silicon layer 20.

The silicon layer 20 is adhered to the surface of the starch container 10 by spraying or other ways.

The function of the silicon layer 20 is to cause the starch container 10 to be waterproof in a short time period. Originally, the starch container 10 is not waterproof. Furthermore in natural environment, the silicon layer 20 and the starch container 10 are capably of decomposition naturally without polluting the environment. Therefore, when the starch container 10 is coated with the silicon layer 20, it is capable of holding water therein and is reusable for many times. It can reduce cost and destroy to the environment. The biological material and silicon has no pollution to the environment and does not affect the health of human body. Therefore, it is better than the prior art used paper cups made of the PP or PE.

Furthermore the silicon layer 20 is endurable to temperatures higher than 250° C. and capable of suffering from high temperature and has the function of killing bacteria in high temperature. The conventionally containers made of PE or PU only suffer from temperatures not over than 20° C. However, the starch container 10 of the present invention is coated with a silicon layer 20 which can suffer from temperatures over than 250° C. Therefore, the medical instruments made of the material of the present invention are useable for killing bacteria on high temperature, while this effect cannot be achieved by the conventional container.

The embodiments of the present invention will be described herein. FIG. 1 shows that the starch container 10 is a cup 100 which is coated with the silicon layer 20 in the interior thereof as illustrated in FIG. 2. The cup 100 is used to hold water and thus is waterproof so as to increase the whole life time of the cup. The cup 100 may be used many times.

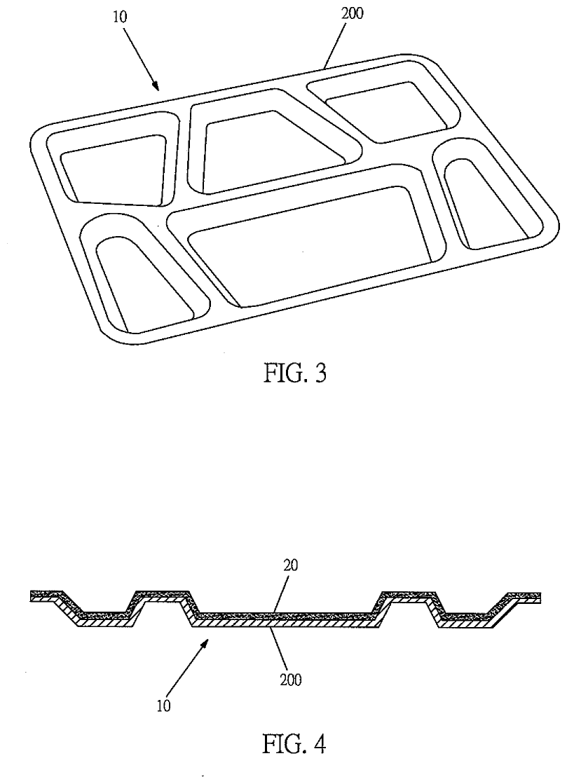

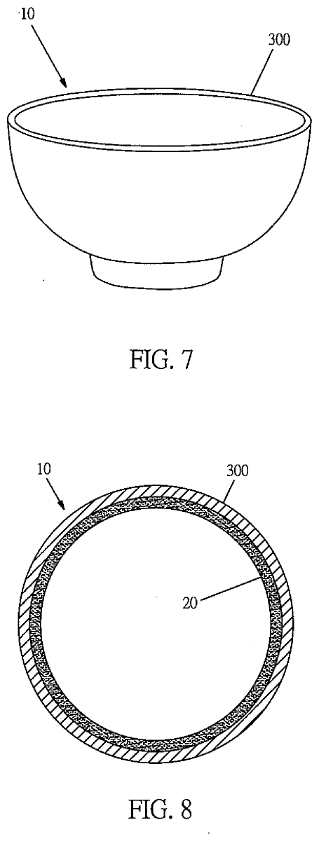

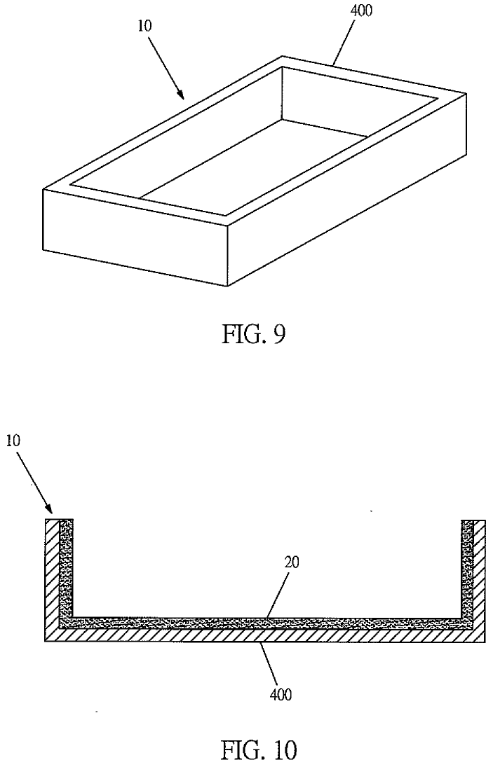

Referring to FIGS. 3 to 5, it is illustrated that the starch container 10 is used as a food disk 200 with a silicon layer 20 at an inner surface thereof as illustrated in FIGS. 4 to 6. Therefore, the whole disk 200 serves to hold foods and is waterproof. It has a longer lifetime and can be used many times. FIG. 7 shows that the starch container 10 is a bowl 300. At least an inner surface of the bowl 300 serves to hold foods or soup and is waterproof so as to increase the lifetime thereof. It can be reused many times. FIG. 9 shows that the starch container 10 is a food box 300. The inner side is coated with a silicon layer 20 as FIG. 10 shows.

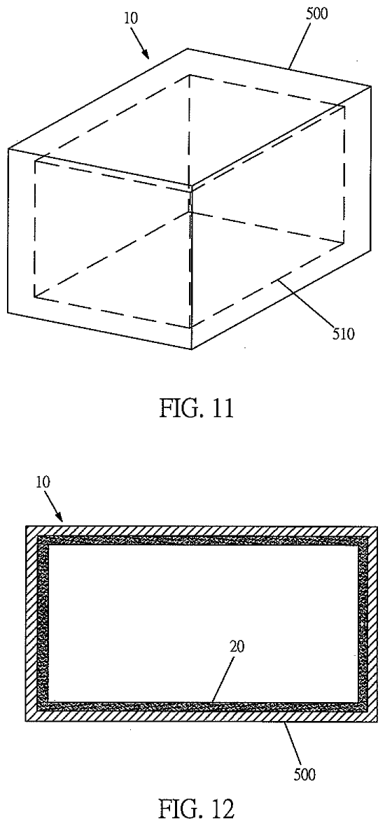

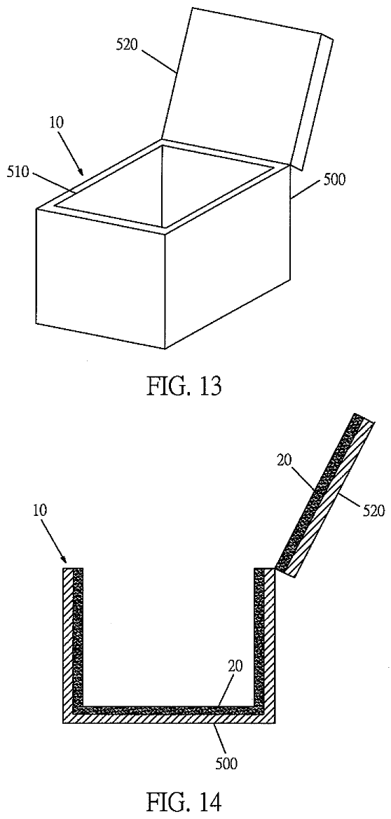

FIG. 11 shows that the starch container 10 is a hollow box 500. At least inner surface of the hollow box 500 is coated with a silicon layer 20 as illustrated in FIG. 12. FIG. 13 shows that the box 500 has a cover 520. At least an inner side of the cover 520 is coated with a silicon layer 20 as FIG. 14 shows.

The starch material of the present invention mainly comprises 50 wt %˜90 wt % (weight percentage) starch; 5 wt %˜25 wt % fiber enhancer (preferably, it is plant fiber or pulp fiber) for enhancing the structure of the starch material; 3 wt %˜30 wt % CaCO3 for hardening the structure of the starch material; preferably, 0.02 wt %˜5 wt % foaming material is added thereto, the foaming material is selected from yeast or generally used chemical foaming material. After forming, 40%˜60% of the volume of the porous starch container 30 is hollowed. The object of foaming is to increase the heat resistance, reduce the weight and material in manufacturing so as to reduce the cost. Preferably, the environment of forming the starch material is high humidity environment (the humidity is about 80%). The starch material is formed as blocks so as to mix with water. To cause water is uniformly distributed in the starch material, the starch material is rubbed many times until the hardness of the surface of the starch material is between 10 HA˜20 HA.

The starch of the starch material is selected from potato starch, corn starch, wood starch, or other plant starches. Because the particles of these starches are not preferred so that in the manufacturing process, water is used to concrete the structure of the starch material.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An environment protected starch container device with high hardness and a function of easy separation from a mold; comprising;
a starch container mainly made of starch material for holding solid or liquid foods or other objects;
a silicon layer adhered to a surface of the starch container; and
wherein the function of the silicon layer is to cause the starch container to be waterproof; originally, the starch container is not waterproof; furthermore in natural environment, the silicon layer and the starch container are capably of decomposition naturally without polluting the environment; therefore the container is capable of holding water therein and is reusable for many times.
wherein the starch material is mixed with stearic acid; a weight of the stearic acid is 1 to 25 wt % (weight percentage) of a weight of the starch material; the mixture of the stearic acid with the starch material 11 has lower viscosity; and therefore, in manufacturing process, the starch container can be taken out from a manufacturing mold easily; and furthermore the stearic acid is easily decomposed so that it has no harm to the environment.

2. The environment protected starch container device with high hardness and a function of easy separation from a mold as claimed in claim 1, wherein the silicon layer further comprises of quartz; a weight of the quartz is 1 to 25 wt % (weight percentage) of the weight of the silicon layer; the quartz has a function of enhancing a hardness of the whole silicon layer so that the hardness of the whole starch container is enhanced.

3. The environment protected starch container device with high hardness and a function of easy separation from a mold as claimed in claim 2, wherein the silicon layer is adhered to an inner surface of the starch container.

4. The environment protected starch container device with high hardness and a function of easy separation from a mold as claimed in claim 1, wherein the silicon layer is adhered to a whole surface of the starch container.

5. The environment protected starch container device with high hardness and a function of easy separation from a mold as claimed in claim 1, wherein the starch container is one of a cup, a food disk, a bowl, and a box.

6. The environment protected starch container device with high hardness and a function of easy separation from a mold as claimed in claim 1, wherein the starch material comprises
50 wt %˜90 wt % (weight percentage) starch;
5 wt %˜25 wt % fiber enhancer for enhancing a structure of the starch material; and
3 wt %˜30 wt % CaCO3 for hardening the structure of the starch material; and
0.02 wt %˜5 wt % foaming material.

7. The environment protected starch container device with high hardness and a function of easy separation from a mold as claimed in claim 6 wherein the fiber enhancer is selected from plant fibers and pulp fibers.

8. The environment protected starch container device with high hardness and a function of easy separation from a mold as claimed in claim 6, wherein the foaming material is selected from yeast and generally used chemical foaming material; and after forming, 40%˜60% of the volume of the porous starch container is hollowed.

9. The environment protected starch container device with high hardness and a function of easy separation from a mold as claimed in claim 6, wherein starch of the starch material is selected from potato starch, corn starch, wood starch, and other plant starch.

10. The environment protected starch container device with high hardness and a function of easy separation from a mold as claimed in claim 6, wherein the starch material is further mixed with at least one of additives including polyethylene (PE), polypropylene (PP), polystyrene (PVC), ethylene, ethylene vinyl acetate (PVC), thermal plastic rubber (TPR); and the weight of the additive is 1 to 10 wt % (weight percentage) of the weight of the starch material.

11. An environment protected starch container device with high hardness and a function of easy separation from a mold; comprising;
a starch container mainly made of starch material for holding solid or liquid foods or other objects;
a silicon layer adhered to a surface of the starch container; and
wherein the function of the silicon layer is to cause the starch container to be waterproof; originally, the starch container is not waterproof; furthermore in natural environment, the silicon layer and the starch container are capably of decomposition naturally without polluting the environment; therefore the container is capable of holding water therein and is reusable for many times.]
wherein the silicon layer further comprises of quartz; a weight of the quartz is 1 to 25 wt % (weight percentage) of the weight of the silicon layer; the quartz has a function of enhancing a hardness of the whole silicon layer so that the hardness of the whole starch container is enhanced.

12. The environment protected starch container device with high hardness and a function of easy separation from a mold as claimed in claim 11, wherein the starch material is mixed with stearic acid; a weight of the stearic acid is 1 to 25 wt % (weight percentage) of a weight of the starch material; the mixture of the stearic acid with the starch material 11 has lower viscosity; and therefore, in manufacturing process, the starch container can be taken out from a manufacturing mold easily; and furthermore the stearic acid is easily decomposed so that it has no harm to the environment.

13. The environment protected starch container device with high hardness and a function of easy separation from a mold as claimed in claim 12, wherein the silicon layer is adhered to an inner surface of the starch container.

14. The environment protected starch container device with high hardness and a function of easy separation from a mold as claimed in claim 11, wherein the silicon layer is adhered to a whole surface of the starch container.

15. The environment protected starch container device with high hardness and a function of easy separation from a mold as claimed in claim 11, wherein the starch container is one of a cup, a food disk, a bowl, and a box.

16. The environment protected starch container device with high hardness and a function of easy separation from a mold as claimed in claim 11, wherein the starch material comprises
50 wt %˜90 wt % (weight percentage) starch;
5 wt %˜25 wt % fiber enhancer for enhancing a structure of the starch material; and
3 wt %˜30 wt % CaCO3 for hardening the structure of the starch material; and
0.02 wt %˜5 wt % foaming material.

17. The environment protected starch container device with high hardness and a function of easy separation from a mold as claimed in claim 16 wherein the fiber enhancer is selected from plant fibers and pulp fibers.

18. The environment protected starch container device with high hardness and a function of easy separation from a mold as claimed in claim 16, wherein the foaming material is selected from yeast and generally used chemical foaming material; and after forming, 40%˜60% of the volume of the porous starch container is hollowed.

19. The environment protected starch container device with high hardness and a function of easy separation from a mold as claimed in claim 16, wherein starch of the starch material is selected from potato starch, corn starch, wood starch, and other plant starch.

20. The environment protected starch container device with high hardness and a function of easy separation from a mold as claimed in claim 16, wherein the starch material is further mixed with at least one of additives including polyethylene (PE), polypropylene (PP), polystyrene (PVC), ethylene, ethylene vinyl acetate (PVC), thermal plastic rubber (TPR); and the weight of the additive is 1 to 10 wt % (weight percentage) of the weight of the starch material.
